(19) United States
(12) Patent Application Publication
(10) Pub. No.: US 2007/0080890 A1
(43) Pub. Date: Apr. 12, 2007

(54) Antenna apparatus

(76) Inventors: Chang-Fa Yang, Taipei City (TW); Shun-Tian Lin, Taipei City (TW); Chao-Hung Lai, Taipei City (TW); Chao-Wei Wang, Taipei City (TW); Yen-Ming Chen, Taipei City (TW); Chuan-Lin Hu, Taipei City (TW); Yu-Wei Chen, Taipei City (TW); Chang-Lun Liao, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/543,808

(22) Filed: Oct. 6, 2006

(30) Foreign Application Priority Data
Oct. 7, 2005 (TW) 94135268

(51) Int. Cl. H01Q 1/36

(52) U.S. Cl. 343/895

(57) ABSTRACT

An antenna apparatus has a substrate, a plurality of meandered conductive strips and a feeding conductive strip disposed on the substrate. The meandered conductive strips have different sizes, and are spaced at intervals and arranged in parallel according to their sizes in order. The feeding conductive strip is electrically connected to the meandered conductive strips. Therefore, a radiating structure having multiple meandered conductive strips can generate electromagnetic mutual coupling, thus obtaining the resonance of multiple and wide-frequency bands.

### RELATED APPLICATIONS

The present application is based on, and claims priority from, Taiwan Application Serial Number 94135268, filed Oct. 7, 2005, the disclosure of which is hereby incorporated by reference herein in its entirety.

### BACKGROUND OF THE INVENTION

1. Field of Invention

The invention relates to an antenna apparatus and, in particular, to a flat antenna apparatus for digital televisions (TVs).

2. Related Art

In the 21^{th} century of modern wireless communication technology and consumer electronics, vehicles are quipped with more communication devices than before. In addition to traditional car stereo AM/FM and analog TV, it is possible for the digital audio broadcasting (DAB), digital video broadcasting (DVB), mobile communications, wireless local area network (WLAN), global positioning system (GPS), and intelligent transportation system (ITS) to become part of the standard equipment in the near future.

The antenna is the window for transmitting and receiving electromagnetic (EM) waves. It has to be specially designed so that it can effectively radiate the radio energy from the emission end into space or receive the EM energy in space and convert it into useful radio signals at the reception end. The quality of an antenna design almost completely determines the performance of the entire communication equipment. It is therefore of great consequence to design a practical antenna that satisfies the communication standards. The antennas may have different shapes and sizes. According to their designs, they can be exposed or hidden ones. Since modem communication systems become more compact, the hidden antennas are expected be the dominant design in the future.

Current digital TVs still use the conventional extending monopole antenna. These antennas do not only have an effect on the appearance of the vehicle, they also make wind-shear and other noises when the cars are running. In the following, we take a couple of relevant patents to explain what drawbacks or shortcomings exist in circuit design and manufacturing of the digital TV antenna in the prior art.

(1) TW Utility Model Patent. No. M269,583:

This patent proposed a digital TV antenna for receiving digital TV signals. The interior of the digital TV antenna is disposed in sequence a lower copper tube, an upper copper tube, and a spring receiver. After the assembly, the upper portion of the spring receiver and the signal line inside the digital TV antenna are soldered together. The cross-sectional area between the lower copper tube, the upper copper tube and the spring receiver and the soldering position between the upper portion of the spring receiver and the signal line are adjusted to reach the required frequency for the digital TV antenna. However, this type of antenna is the monopole antenna. It has a larger size and limited applications.

(2) TW Patent Post-Granted Pub. No. 521,455:

This patent proposes a flat miniaturized antenna for digital TVs. The antenna includes a substrate and several antennas. The upper and lower surfaces of the substrate are formed with strip lines by copper foil printing. A connector is disposed at the center of the strip line on the lower surface. A feeding line penetrates through and connects the upper and lower surfaces of the substrate. Both sides of the strip line are extended in the perpendicular direction with several electrically coupled line-shaped antennas, distributed in the second and fourth quadrants of each surface of the substrate. Each quadrant has three sets of antennas disposed in parallel. The length of the outer antenna is larger than that of the inner one. The antennas in the second and fourth quadrants are disposed with mirror symmetry. Several cracks are formed at places where each set of antennas are close to the strip line, generating capacitor couplings for LC resonance and thereby obtaining wide frequency bands. However, the miniaturized antenna thus obtained still has a large size for the required wide band, not suitable for modem applications.

### SUMMARY OF THE INVENTION

An objective of the invention is to provide an antenna apparatus that uses multiple coupling circuits and multiple current paths to achieve the effects of multiple bands and wide-frequency bands with a small antenna size.

According to a preferred embodiment of the invention, the antenna apparatus includes a substrate and several meandered conductive strips and a feeding conductive strip disposed thereon. The meandered conductive strips have different sizes, and are spaced at intervals and arranged in parallel according to their sizes in order. The feeding conductive strip is electrically connected to the meandered conductive strips.

According to another embodiment of the invention, the antenna apparatus includes a substrate and two conductive strip sets disposed thereon. Each of the conductive strip sets contains several meandered conductive strips and a feeding conductive strip. The meandered conductive strips in each conductive strip set have different sizes, and are spaced at intervals and arranged in parallel according to their sizes in order. The feeding conductive strip is electrically connected to the meandered conductive strips. Moreover, each meandered conductive strip has an opening. The two openings belonging to two different conductive strip sets are disposed opposite to each other.

Another objective of the invention is to provide a digital TV antenna apparatus whose strip width, spacing, shape, and feeding point can be adjusted according to the specifications and requirements. The electromagnetic mutual coupling effect is employed to increase the frequency width but reduce the size of the antenna.

According to another embodiment of the invention, the digital TV antenna apparatus includes a substrate and several U-shaped conductive strips and at least one feeding conductive strip disposed thereon. The U-shaped conductive strips have different sizes, and are spaced at intervals and arranged in parallel according to their sizes in order. The feeding conductive strip is electrically connected to the U-shaped conductive strips.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1A is a schematic view of the first embodiment;

FIG. 1B shows the antenna return loss of the antenna apparatus of FIG. 1A;

FIG. 2A is a schematic view of the second embodiment;

FIG. 2B shows the antenna return loss of the antenna apparatus of FIG. 2A;

FIG. 3A is a schematic view of the third embodiment;

FIG. 3B shows the antenna return loss of the antenna apparatus of FIG. 3A;

FIG. 4A is a schematic view of the fourth embodiment; and

FIG. 4B shows the antenna return loss of the antenna apparatus of FIG. 4A.

### DETAILED DESCRIPTION OF THE INVENTION

The present invention will be apparent from the following detailed description, which proceeds with reference to the accompanying drawings, wherein the same references relate to the same elements.

The invention uses a feeding conductive strip and several multiply meandered conductive strips to form an antenna apparatus. The coupling among different conductive strips can produce the resonance of multiple and wide-frequency bands and reduce the antenna size.

### First Embodiment

In this embodiment, several meandered conductive strips of different sizes are spaced at intervals and arranged in parallel. The multiple coupling effect is used to obtain a small antenna apparatus with a wide band. A person skilled in the art can take into account the required antenna frequency, bandwidth, and field shape to adjust the strip shape, opening direction, strip width, interval, and position of the ground surface in order to obtain better antenna performance.

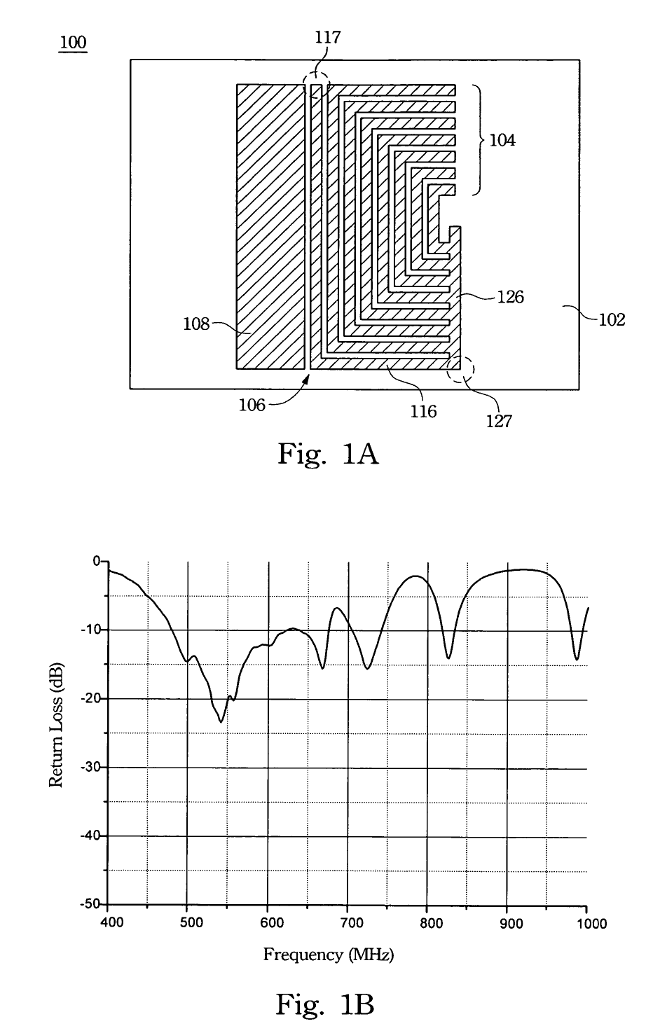

FIG. 1A is a schematic view of the first embodiment. The antenna apparatus 100 includes a substrate 102 and several meandered conductive strips 104 and a feeding conductive strip 106 disposed thereon. The meandered conductive strips 104 have different sizes, and are spaced at interval and arranged in parallel according to their sizes in order. The feeding conductive strip 106 is electrically connected to the meandered conductive strips 104.

More explicitly, after a signal enters via the feeding point 117 of the feeding conductive strip 106, multiple branch paths are formed at the strip location 127, thereby generating many current paths of different lengths. Under this current path structure, the current distribution along the shorter current paths generates resonance at higher frequencies. The current distribution along the longer current paths generates resonance at lower frequencies. Therefore, the entire antenna apparatus has multiple and wide-frequency bands.

In different embodiments of the invention, the shapes of the meandered conductive strips 104 can be semi-circular, semi-annular, U-shaped, <-shaped, L-shaped, their combinations, or any other strips with an opening. Besides, the openings of the meandered conductive strips 104 are essentially toward the same direction. In practice, these openings may need to have some angular differences due to the design. Moreover, the width of these meandered conductive strips 104 can be the same or different. That is, the meandered conductive strips 104 in the same antenna apparatus 100 may have the same strip width, or their widths can be tuned to obtain optimized radiation field shape or effects. Likewise, the interval between the meandered conductive strips 104 can be the same or different.

The feeding conductive strip 106 in FIG. 1A has a connecting portion 126 and an L-shaped portion 116. The connecting portion 126 is electrically coupled to the meandered conductive strips 104. The L-shaped portion 116 is spaced at an interval and arranged in parallel on the outermost side of the meandered conductive strips 104. In this embodiment, the signal enters the antenna apparatus 100 via the feeding point 117 at one end of the L-shaped portion 116. In practice, the feeding point and the ground point can be assigned at arbitrary positions. The frequency of the antenna apparatus 100 is shifted by varying the strip length. That is, different positions of the feeding and ground points can be selected to fine-tune the frequency range used by the antenna apparatus 100 to emit and receive signals.

The material of the substrate 102 can be a dielectric or insulating material, such as the printed circuit board (PCB). The material of the conductive strips 104, 106 can be metal, alloy, or other conductive materials. For example, they can be made of copper. In this embodiment, the conductive strips are covered with a protection layer or a dielectric layer with a higher dielectric constant. For example, the conductive strips are inserted into the dielectric material by insert molding. Not only can this protect the conductive strips from being damaged, it also reduces the strip size of the antenna apparatus 100 using the dielectric material.

Besides, the antenna apparatus 100 can further include a ground surface 108 electrically connected to one of the meandered conductive strips 104. In addition to providing the ground, it further couples with the conductive strips for reducing the antenna size. The ground surface 108 can be disposed by the meandered conductive strips 104, as shown in FIG. 1A. It can also be disposed on the other surface (not shown) of the substrate 102, opposite to the meandered conductive strips 104. In other words, the ground surface 108 can be disposed on the right-hand side of, the left-hand side of, or underneath the meandered conductive strips 104, achieving different effects. In accord with other embodiments of the invention, there may be simultaneously two ground surfaces at different positions on the substrate 102. For example, one is disposed by the meandered conductive strips 104, and the other is disposed on the other surface of the substrate 102. In addition to providing the ground, they also change the EM mutual coupling of the antenna apparatus 100.

FIG. 1B shows the frequency response diagram for the antenna return loss of the antenna apparatus 100 in FIG. 1A. The vertical axis is the return loss in units of dB, and the horizontal axis is the antenna frequency in units of MHz. In this embodiment, the widths of the meandered conductive strips 104 and the feeding conductive strip 106 are both 1.6 mm, and the interval is 0.8 mm. It should be emphasized that the size of each meandered conductive strip 104 and feeding conductive strip 106 can be adjusted according to the application to obtain the required frequency resonance. In FIG. 1B, the frequency range for the −3 dB return loss of the antenna apparatus 100 is between 430 MHz and 760 MHz, with a bandwidth of 330 MHz that meets the UHF ground broadcasting digital TV system requirements in most regions of the world (Taiwan: 530 MHz˜602 MHz; Global: 470 MHz˜860 MHz).

### Second Embodiment

In the second embodiment, two conductive strip sets with opposite openings are disposed on the same substrate. Each conductive strip set has several meandered conductive strips and a feeding conductive strip. Moreover, the two conductive strip sets have the same number of meandered conductive strips, and the feeding conductive strip partially overlaps with one of the meandered conductive strips. Besides, the ground surface in this embodiment is disposed on the other surface of the substrate.

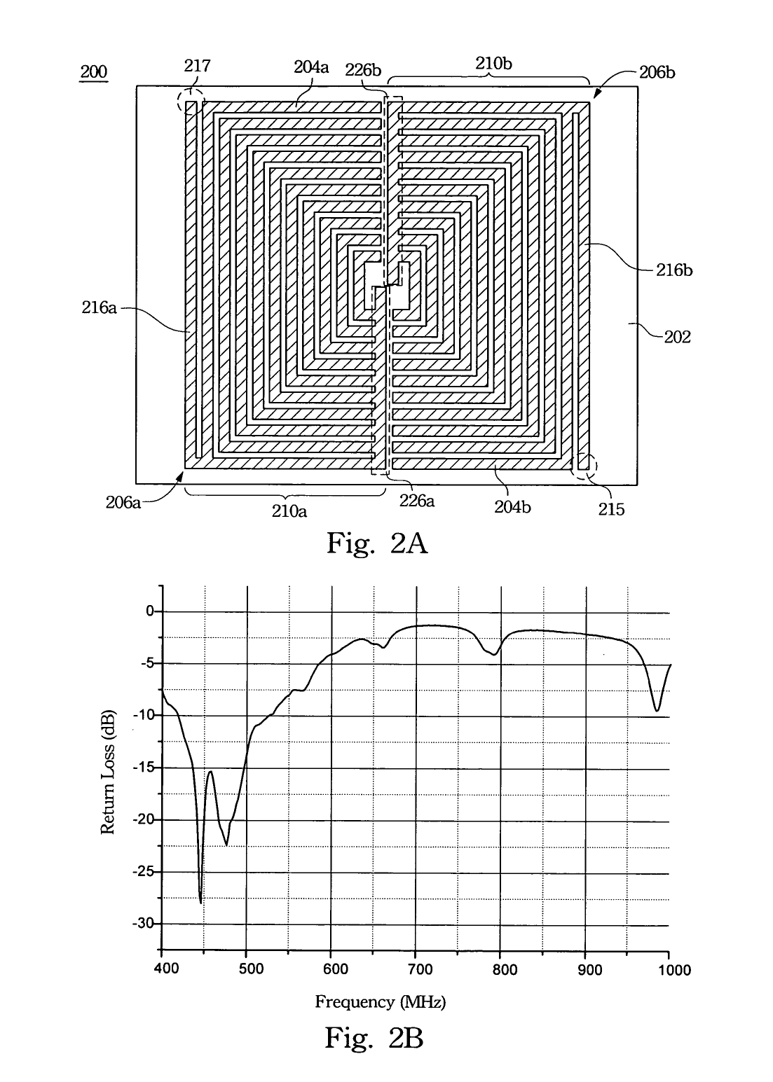

FIG. 2A is a schematic view of the second embodiment. The antenna apparatus 200 includes a substrate 202, and a first conductive strip set 210a and a second conductive strip set 210b disposed thereon. The first conductive strip set 210a has several first meandered conductive strips 204a and a first feeding conductive strip 206a. The first feeding conductive strip 206a is electrically connected to the first meandered conductive strips 204a. The first meandered conductive strips 204a have different sizes, and are spaced at intervals and arranged in parallel according to their sizes in order.

The second conducive strip set 210b has several second meandered conductive strips 204b and a second feeding conductive strip 206b. The second feeding conductive strip 206b is electrically connected to the second meandered conductive strips 204b. The second meandered conductive strips 204b have different sizes, and are spaced at intervals and arranged in parallel according to their sizes in order. Moreover, each set of the meandered conductive strips has an opening. The openings belonging to the first conductive strip set 210a and the second conductive strip set 210b are disposed opposite to each other.

According to different embodiments of the invention, the shapes of the meandered conductive strips 204a, 204b can be semi-circular, semi-annular, U-shaped, <-shaped, L-shaped, their combinations, or any other strips with an opening. Besides, the openings of the meandered conductive strips 204a or 204b in the same set are essentially toward the same direction. In this embodiment, the first conductive strip set 210a and the second conductive strip set 210b have the same number of first meandered conductive strips 204a and second meandered conductive strips 204b. The two conductive strip sets 210a, 210b are disposed on the substrate 202 in a mutually inverted way.

The first feeding conductive strip 206a has a first connection portion 226a and a first L-shaped portion 216a. The first connecting portion 226a is electrically connected to the first meandered conductive strips 204a. The first L-shaped portion 216a partially overlaps with the outermost first meandered conductive strip 204a. The second feeding conductive strip 206b has a second connection portion 226b and a second L-shaped portion 216b. The second connecting portion 226b is electrically connected to the second meandered conductive strips 204b. The second L-shaped portion 216b partially overlaps with the outermost second meandered conductive strip 204b.

In this embodiment, a signal enters the antenna apparatus 200 via the feeding point 217 at one end of the first L-shaped portion 216a. The ground point 215 is disposed on one end of the second L-shaped portion 216b. In practice, one can select arbitrary positions as the feeding point and the ground point for signal input. The frequency of the antenna apparatus 200 is shifted by varying the strip length. Alternatively, the positions of the feeding point 217 and the ground point 215 can be directly interchanged. That is, different positions of the feeding and ground points can be selected to fine-tune the frequency range used by the antenna apparatus 200 to emit and receive signals.

The widths of these meandered conductive strips 204a, 204b can be the same or different. The intervals of the meandered conductive strips 204a, 204b can be the same or different as well. For example, the meandered conductive strips 204a, 204b of different conductive strip sets can have the same or different widths and intervals. The meandered conductive strips 204a or 204b within the same conductive strip set can have the same or different widths and intervals.

The material of the substrate 202 can be a dielectric or insulating material, such as the PCB. The material of the conductive strips 204a, 204b, 206a, 206b can be metal, alloy, or other conductive materials. For example, they can be made of copper. Besides, the antenna apparatus 200 can further include a ground surface (not shown) electrically connected to the ground point 215. Since the ground point 215 can be at any arbitrary position on the conductive strips, the ground surface can be electrically connected to one of the meandered conductive strips 204a, 204b.

The ground surface can be disposed by the meandered conductive strips 204a, 204b, as shown in FIG. 2A. It can also be disposed on the other surface (not shown) of the substrate 202, opposite to the meandered conductive strips 204a, 204b. Alternatively, two ground surfaces are disposed simultaneously on the substrate 202, one by the meandered conductive strips 204a, 204b, and the other on the other surface of the substrate 202. In addition to providing the ground, they also change the EM mutual coupling of the antenna apparatus 200.

FIG. 2B shows the frequency response diagram for the antenna return loss of the antenna apparatus 200 in FIG. 2A. The vertical axis is the return loss in units of dB, and the horizontal axis is the antenna frequency in units of MHz. In this embodiment, the widths of the meandered conductive strips 204a, 204b and the feeding conductive strips 206a, 206b are all 1.6 mm, and the interval is 0.8 mm. It should be emphasized that the size of each set of meandered conductive strips 204a, 204b and feeding conductive strips 206a, 206b can be adjusted according to the application to obtain the required frequency resonance. In FIG. 2B, the frequency range for the −3 dB return loss of the antenna apparatus 200 is between 400 MHz and 620 MHz, with a bandwidth of at least 220 MHz that meets the UHF ground broadcasting digital TV system requirements in most regions of the world.

### Third Embodiment

In this embodiment, the two conductive strip sets with opposite openings can have different numbers of and asymmetric meandered conductive strips. The feeding conductive strips in the two conductive strip sets can have different shapes and lengths. One of them is spaced at an interval and arranged in parallel on the outermost side of the meandered conductive strips. The other partially overlaps with the outermost meandered conductive strip.

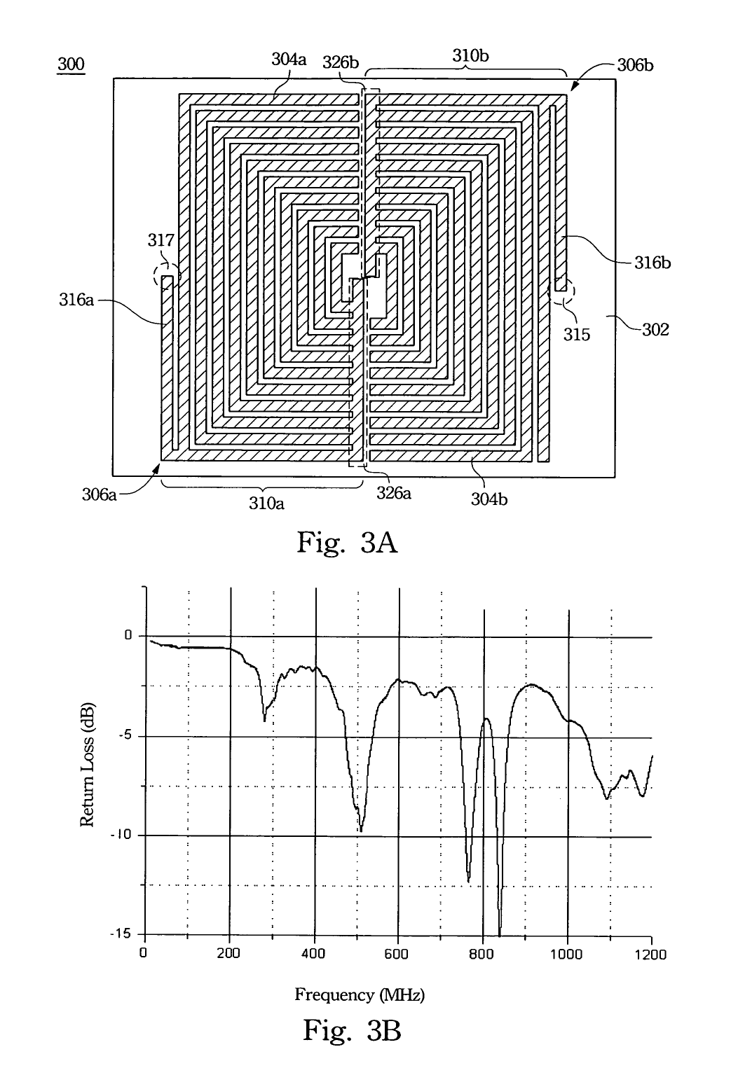

FIG. 3A is a schematic view of the third embodiment. The antenna apparatus 300 includes a substrate 302, and a first conductive strip set 310a and a second conductive strip set 310b disposed thereon. The first conductive strip set 310a has several first meandered conductive strips 304a and a first feeding conductive strip 306a. The first feeding conductive strip 306a is electrically connected to the first meandered conductive strips 304a. The first meandered conductive strips 304a have different sizes, and are spaced at intervals and arranged in parallel according to their sizes in order.

The second conducive strip set 310b has several second meandered conductive strips 304b and a second feeding conductive strip 306b. The second feeding conductive strip 306b is electrically connected to the second meandered conductive strips 304b. The second meandered conductive strips 304b have different sizes, and are spaced at intervals and arranged in parallel according to their sizes in order. Moreover, each set of the meandered conductive strips 304a, 304b has an opening. The openings belonging to the first conductive strip set 310a and the second conductive strip set 310b are disposed opposite to each other.

According to different embodiments of the invention, the shapes of the meandered conductive strips 304a, 304b can be semi-circular, semi-annular, U-shaped, <-shaped, L-shaped, their combinations, or any other strips with an opening. Besides, the openings of the meandered conductive strips 304a or 304b in the same set are essentially toward the same direction. In this embodiment, the first conductive strip set 310a and the second conductive strip set 310b have different numbers of first meandered conductive strips 304a and second meandered conductive strips 304b.

The first feeding conductive strip 306a has a first connection portion 326a and a first L-shaped portion 316a. The first connecting portion 326a is electrically connected to the first meandered conductive strips 304a. The first L-shaped portion 316a partially overlaps with the outermost first meandered conductive strip 304a. The second feeding conductive strip 306b has a second connection portion 326b and a second F-shaped portion 316b. The second connecting portion 326b is electrically connected to the second meandered conductive strips 304b. The second F-shaped portion 316b is spaced at an interval and arranged in parallel to the outermost second meandered conductive strip 304b.

In this embodiment, a signal enters the antenna apparatus 300 via the feeding point 317 at one end of the first L-shaped portion 316a. The ground point 315 is disposed on one end of the second F-shaped portion 316b. In practice, one can select arbitrary positions as the feeding point and the ground point for signal input. The frequency of the antenna apparatus 300 is shifted by varying the strip length. Alternatively, the positions of the feeding point 317 and the ground point 315 can be directly interchanged. That is, different positions of the feeding and ground points can be selected to fine-tune the frequency range used by the antenna apparatus 300 to emit and receive signals. Likewise, the first L-shaped portion 316a and the second F-shaped potion 316b can be appropriately elongated or shortened to achieve the goal of fine-tuning the band range of the antenna apparatus 300.

The widths of these meandered conductive strips 304a, 304b can be the same or different. The intervals of the meandered conductive strips 304a, 304b can be the same or different as well. For example, the meandered conductive strips 304a, 304b of different conductive strip sets can have the same or different widths and intervals. The meandered conductive strips 304a or 304b within the same conductive strip set can have the same or different widths and intervals.

The material of the substrate 302 can be a dielectric or insulating material, such as the PCB. The material of the conductive strips 304a, 304b, 306a, 306b can be metal, alloy, or other conductive materials. For example, they can be made of copper. Besides, the antenna apparatus 300 can further include a ground surface (not shown) electrically connected to the ground point 315. Since the ground point 315 can be at any arbitrary position on the conductive strips, the ground surface can be electrically connected to one of the meandered conductive strips 304a, 304b.

The ground surface can be disposed by the meandered conductive strips 304a, 304b, as shown in FIG. 3A. It can also be disposed on the other surface (not shown) of the substrate 302, opposite to the meandered conductive strips 304a, 304b. Alternatively, two ground surfaces are disposed simultaneously on the substrate 302, one by the meandered conductive strips 304a, 304b, and the other on the other surface of the substrate 302. In addition to providing the ground, they also change the EM mutual coupling of the antenna apparatus 300.

FIG. 3B shows the frequency response diagram for the antenna return loss of the antenna apparatus 300 in FIG. 3A. The vertical axis is the return loss in units of dB, and the horizontal axis is the antenna frequency in units of MHz. In this embodiment, the widths of the meandered conductive strips 304a, 304b and the feeding conductive strips 306a, 306b are all 1.6 mm, and the interval is 0.8 mm. It should be emphasized that the size of each set of meandered conductive strips 304a, 304b and feeding conductive strips 306a, 306b can be adjusted according to the application to obtain the required frequency resonance. In FIG. 3B, the frequency range for the −3 dB return loss of the antenna apparatus 300 is between 270 MHz and 310 MHz, between 450 MHz and 560 MHz, and between 740 MHz and 880 MHz that meet the VHF and UHF ground broadcasting digital TV system requirements in most regions of the world.

### Fourth Embodiment

In this embodiment, the F-shaped portions of the feeding conductive strips can have different lengths in order to obtain a frequency band between 470 MHz and 860 MHz. Therefore, the antenna apparatus in this case is particularly suitable for receiving the radio signals for UHF ground broadcasting digital TVs.

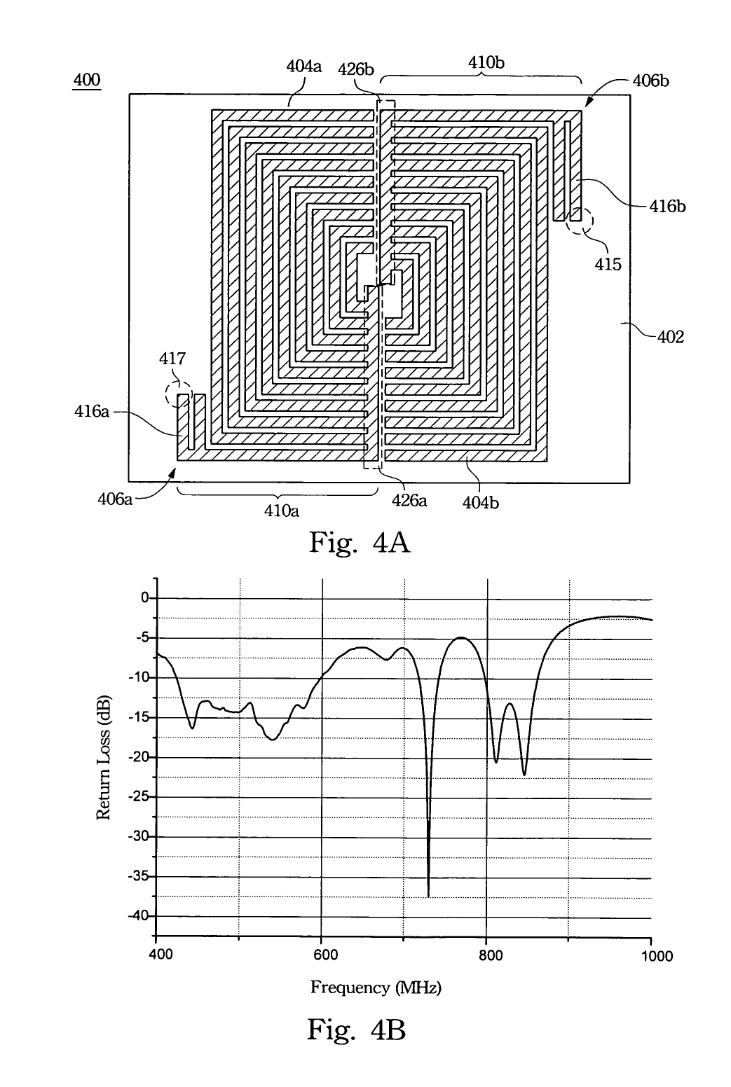

FIG. 4A is a schematic view of the fourth embodiment. The antenna apparatus 400 includes a substrate 402, and a first conductive strip set 410a and a second conductive strip set 410b disposed thereon. The first conductive strip set 410a has several first meandered conductive strips 404a and a first feeding conductive strip 306a. The first feeding conductive strip 406a is electrically connected to the first meandered conductive strips 404a. The first meandered conductive strips 404a have different sizes, and are spaced at intervals and arranged in parallel according to their sizes in order.

The second conducive strip set 410b has several second meandered conductive strips 404b and a second feeding conductive strip 406b. The second feeding conductive strip 406b is electrically connected to the second meandered conductive strips 404b. The second meandered conductive strips 304b have different sizes, and are spaced at intervals and arranged in parallel according to their sizes in order. Moreover, each set of the meandered conductive strips 404a, 404b has an opening. The openings belonging to the first conductive strip set 410a and the second conductive strip set 410b are disposed opposite to each other.

According to different embodiments of the invention, the shapes of the meandered conductive strips 404a, 404b can be semi-circular, semi-annular, U-shaped, <-shaped, L-shaped, their combinations, or any other strips with an opening. Besides, the openings of the meandered conductive strips 404a or 404b in the same set are essentially toward the same direction. In this embodiment, the first conductive strip set 410a and the second conductive strip set 410b have the same numbers of first meandered conductive strips 404a and second meandered conductive strips 404b.

The first feeding conductive strip 406a has a first connection portion 426a and a first F-shaped portion 416a. The first connecting portion 426a is electrically connected to the first meandered conductive strips 404a. The first F-shaped portion 416a partially overlaps with the outermost first meandered conductive strip 404a. The second feeding conductive strip 406b has a second connection portion 426b and a second F-shaped portion 416b. The second connecting portion 426b is electrically connected to the second meandered conductive strips 404b. The second F-shaped portion 416b is spaced at an interval and arranged in parallel to the outermost second meandered conductive strip 404b.

In this embodiment, a signal enters the antenna apparatus 400 via the feeding point 417 at one end of the first F-shaped portion 416a. The ground point 415 is disposed on one end of the second F-shaped portion 416b. In practice, one can select arbitrary positions as the feeding point and the ground point for signal input. The frequency of the antenna apparatus 400 is shifted by varying the strip length. Alternatively, the positions of the feeding point 417 and the ground point 415 can be directly interchanged. That is, different positions of the feeding and ground points can be selected to fine-tune the frequency range used by the antenna apparatus 400 to emit and receive signals. Likewise, the first F-shaped portion 416a and the second F-shaped potion 416b can be appropriately elongated or shortened to achieve the goal of fine-tuning the band range of the antenna apparatus 400.

The widths of these meandered conductive strips 404a, 404b can be the same or different. The intervals of the meandered conductive strips 404a, 404b can be the same or different as well. For example, the meandered conductive strips 404a, 404b of different conductive strip sets can have the same or different widths and intervals. The meandered conductive strips 404a or 404b within the same conductive strip set can have the same or different widths and intervals.

The material of the substrate 402 can be a dielectric or insulating material, such as the PCB. The material of the conductive strips 404a, 404b, 406a, 406b can be metal, alloy, or other conductive materials. For example, they can be made of copper. Besides, the antenna apparatus 400 can further include a ground surface (not shown) electrically connected to the ground point 415. Since the ground point 415 can be at any arbitrary position on the conductive strips, the ground surface can be electrically connected to one of the meandered conductive strips 404a, 404b.

The ground surface can be disposed by the meandered conductive strips 404a, 404b, as shown in FIG. 4A. It can also be disposed on the other surface (not shown) of the substrate 402, opposite to the meandered conductive strips 404a, 404b. Alternatively, two ground surfaces are disposed simultaneously on the substrate 402, one by the meandered conductive strips 404a, 404b, and the other on the other surface of the substrate 402. In addition to providing the ground, they also change the EM mutual coupling of the antenna apparatus 400.

FIG. 4B shows the frequency response diagram for the antenna return loss of the antenna apparatus 400 in FIG. 4A. The vertical axis is the return loss in units of dB, and the horizontal axis is the antenna frequency in units of MHz. In this embodiment, the widths of the meandered conductive strips 404a, 404b and the feeding conductive strips 406a, 406b are all 1.6 mm, and the interval is 0.8 mm. It should be emphasized that the size of each set of meandered conductive strips 404a, 404b and feeding conductive strips 406a, 406b can be adjusted according to the application to obtain the required frequency resonance. As shown in the drawing, the feeding conductive strips of the antenna apparatus 400 has one more short strip than the feeding conductive strip of the antenna apparatus 300 in FIG. 3A. In FIG. 4B, the frequency range for the −3 dB return loss of the antenna apparatus 400 is between 470 MHz and 880 MHz that meets the UHF ground broadcasting digital TV system requirements in most regions of the world.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An antenna apparatus, comprising:
a substrate:
a plurality of meandered conductive strips disposed on the substrate, therein the meandered conductive strips having different sizes and being spaced at intervals and arranged in parallel according to their sizes in order; and
a feeding conductive strip disposed on the substrate, wherein the feeding conductive strip is electrically connected to the meandered conductive strips.

2. The antenna apparatus of claim 1, wherein the shape of the meandered conductive strips is semi-circular, semi-annular, U-shaped, <-shaped, L-shaped, or their combinations.

3. The antenna apparatus of claim 2, wherein the openings of the meandered conductive strips are toward the same or different directions.

4. The antenna apparatus of claim 2, wherein the widths of the meandered conductive strips are the same or different.

5. The antenna apparatus of claim 2, wherein the intervals between the meandered conductive strips are the same or different.

6. The antenna apparatus of claim 2, further comprising a ground surface connected to one of the meandered conductive strips, wherein the ground surface is disposed by the meandered conductive strips or on the other surface opposite to the meandered conductive strips.

7. An antenna apparatus, comprising:
a substrate; and
two conductive strip sets disposed on the substrate, each of which has:
a plurality of meandered conductive strips of different sizes spaced at intervals and arranged in parallel according to their sizes in order; and
a feeding conductive strip electrically connected to the meandered conductive strips.

8. The antenna apparatus of claim 7, wherein the shape of the meandered conductive strips is semi-circular, semi-annular, U-shaped, <-shaped, L-shaped, or their combinations.

9. The antenna apparatus of claim 8, wherein the openings of the meandered conductive strips are toward the same or different directions.

10. The antenna apparatus of claim 8, wherein the widths of the meandered conductive strips are the same or different.

11. The antenna apparatus of claim 8, wherein the intervals between the meandered conductive strips are the same or different.

12. The antenna apparatus of claim 8, wherein the conductive strip sets have the same or different numbers of the meandered conductive strips.

13. The antenna apparatus of claim 7, wherein each of the meandered conductive strips has an opening and the openings of the two conductive strip sets are toward the same or different directions.

14. The antenna apparatus of claim 8, further comprising a ground surface connected to one of the meandered conductive strips, wherein the ground surface is disposed by the meandered conductive strips or on the other surface opposite to the meandered conductive strips.

15. The antenna apparatus of claim 7, wherein the feeding conductive strip has a connecting portion and an L-shaped portion, the connecting portion is electrically connected to the meandered conductive strips, and the L-shaped portion is spaced at an interval and arranged in parallel on the outermost side of the meandered conductive strips or partially overlapped with one of the meandered conductive strips.

16. The antenna apparatus of claim 7, wherein the feeding conductive strip has a connecting portion and an F-shaped portion, the connecting portion is electrically connected to the meandered conductive strips, and the F-shaped portion is spaced at an interval and arranged in parallel on the outermost side of the meandered conductive strips or partially overlapped with one of the meandered conductive strips.

17. The antenna apparatus of claim 7, wherein the feeding conductive strip has a connecting portion and a multiple-strip portion, the connecting portion is electrically connected to the meandered conductive strips, and the multiple-strip portion is spaced at an interval and arranged in parallel on the outermost side of the meandered conductive strips or partially overlapped with one of the meandered conductive strips.

18. The antenna apparatus of claim 7, wherein the antenna apparatus is used for transmitting/receiving signals of VHF or UHF digital TVs mobile communication devices, and other wireless communication devices.
